(19) United States
(12) Patent Application Publication
(10) Pub. No.: US 2002/0120556 A1
(43) Pub. Date: Aug. 29, 2002

(54) Auction system using network and auction program as well as storage medium on which program is stored

(75) Inventor: Makiko Saito, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/083,471

(22) Filed: Feb. 27, 2002

(30) Foreign Application Priority Data
Feb. 28, 2001 (JP) 2001-053949

(51) Int. Cl. G06F 17/60

(52) U.S. Cl. 705/37

(57) ABSTRACT

The invention provides an auction system by which reduction of the charge for delivery of a commodity to be borne by parties in an auction is achieved while the merits to the parties by the auction are assured thereby to achieve activation of the auction. The auction system includes a server in which an auction site which determines a successful bidder for an auction commodity based on bids performed from user terminals through a network is formed. The server exhibits, in the auction site, a delivery charge bearing object commodity to be sold by a dealer who bears part or all of the delivery charge for the auction commodity for which the user becomes the successful bidder, and performs sales processing of the delivery charge bearing object commodity in combination with the auction commodity in response to a request from a user terminal.

### BACKGROUND OF THE INVENTION

1. Field of the Invention

The present invention relates to an auction system, and more particularly to a system and a program for performing an auction using a network.

2. Description of the Related Art

In recent years, personal computers have spread rapidly into common homes, and the frequency in connection to the Internet has been and is increasing. Also portable telephone sets which can be connected to the Internet have been and are being spread, and the Internet connecting population is increasing. As a result, it has been popularized to perform a public sale (Internet auction) or shopping of a commodity on the Internet. Accordingly, the form of transaction of a commodity has become diversified, and it is possible to take part in shopping or an auction on the Internet, that is, to purchase a commodity at home.

The Internet auction signifies a transaction in the form of an auction performed on the Internet between a person who wants to sell a commodity at a high price and another person who wants to buy a commodity at a low price without the intervention of an intermediator. Accordingly, a user of a terminal can access a homepage from the terminal to display (to register a commodity to be sold into an auction site on the Internet) or bid (that is, a displaying person presents an estimated value of a commodity of the displaying person itself so that a competitor (another bidder) can access it in accordance with the agreement that a displaying person will conclude a contract with a person who has proposed the most favorite condition) for a commodity on the homepage.

The site (auction administrator) which manages personal information of the auction stores displaying persons (personal sellers) and successful bidders (purchasers) into a database, in which such personal information is coordinated with auction commodities which are objects of merchandise. A displaying person registers information of a commodity to be sold into the database, and a successful bidder who proposes the highest value for the commodity becomes the purchaser of the commodity.

More particular, when a person tries to display a commodity in an auction, it first registers its user information into the auction site. The user information in this instance may be basic information of the user such as an address, the full name and the age. As information necessary to display a commodity, selection of a category, an upset price, a method of payment, a method of delivery, a period and so forth as commodity information are entered. Further, where an image is available, it is possible to upload it into the site. Further, the method of payment maybe selected from, for example, transfer to a bank account, transfer to a postal transfer account, cash registration, payment on delivery or payment through a credit card. As the delivery method, the delivery charge is borne by the successful bidder or the displaying person. When a displaying person tries to display a commodity, it will select and determine favorite ones from among the choices mentioned above as sales conditions. Then, if any purchaser finds out a favorite commodity based on a category or through a search and determines to bid for the commodity, it registers its user information. Thereafter, the purchaser will bid a desired value for the commodity. If a competitor or competitors are present, then bidding is performed. Thereafter, when the auction for the commodity comes to an end with a successful bidder determined, then such notification is delivered from the auction site to the displaying person and the successful bidder. In the notification, male addresses and so forth of the displaying person and the successful bidder are entered. At this point of time, the information exchange at the auction site is completed, and a delivery method of the commodity and a method of payment for the commodity are determined through exchange of mails between the displaying person and the successful bidder or the like. However, the method of payment and so forth are normally performed in accordance with a method registered in advance by the personal seller.

The conventional Internet auction described above, however, has such disadvantages as described below.

In particular, the conventional auction adopts the form of personal transaction without an intermediator since the object of it is to allow a personal seller and a purchaser to sell and buy a commodity at a possible minimum cost. Accordingly, although the auction provides high merits to them in terms of the transaction of a commodity, the charge for delivery is always present as a cost other than the expenses for the transaction. In other words, there is a problem that a seller or a purchaser must bear the charge for delivery of an auction commodity.

Further, also such a situation that a seller and a purchaser dispute each other regarding which one of the seller and the purchaser should bear the charge for delivery occurs, and this gives rise to a problem that the transaction does not proceed smoothly.

### SUMMARY OF THE INVENTION

It is an object of the present invention to provide an auction system by which reduction of the charge for delivery to be borne by parties in an auction is achieved while the merits to the parties by the auction are assured thereby to achieve activation of the auction.

In order to attain the object described above, according to an aspect of the present invention, there is provided an auction system, comprising a plurality of user terminals, and a server connected-to the user terminals through a network and having an auction site formed therein for receiving bids from the user terminals and determining a successful bidder for an auction commodity based on the received bids, the server exhibiting, in the auction site thereof, a delivery charge bearing object commodity which is to be sold by a dealer and with which part or all of a delivery charge for the auction commodity for which a user is determined as a successful bidder is to be borne so that the delivery charge bearing object commodity may be sold in combination with the auction commodity in response to a request from one of the user terminals.

With the auction system, an auction commodity and a delivery charge bearing object commodity are sold in the auction site. If a user purchases the commodities, then part or all of the delivery charge which should be borne by the user is borne by the dealer. Accordingly, reduction of the delivery charge to be borne by the auction user can be anticipated, and activation of the auction can be anticipated.

According to another aspect of the present invention, there is provided an auction system, comprising a plurality of personal seller terminals and a plurality of participant terminals, and an auction server connected to the personal seller terminals and the participant terminals through a network, the auction server having an auction information reception storage function for receiving and storing auction commodity information from the personal seller terminals, an auction information transmission function for transmitting the auction commodity information to any of the participant terminals in response to a request from the participant terminal, and an auction function for receiving bidding information from the participant terminals based on the auction commodity information and determining a successful bidder based on the bidding information, the auction server further having a dealer information reception storage function for receiving, from a dealer terminal owned by a predetermined dealer and connected to the auction server through the network, and storing dealer provision information including dealer commodity information which is information regarding a commodity to be sold by the dealer and delivery charge information which is information regarding the charge for delivery to be borne by the dealer in place of the person who purchases the dealer commodity, the auction information transmission function placing and transmitting the dealer provision information into and together with the information to be transmitted to the participant terminal, the auction function receiving purchase desired commodity information corresponding to the dealer provision information transmitted from the participant terminals together with the bidding information.

With the auction system, auction commodity information and dealer provision information are transmitted to each participant terminal, and an auction participant who operates its participant terminal can acquire information required for an auction commodity, information regarding a commodity to be sold by a predetermined dealer and information regarding the delivery charge to be borne by the dealer. Then, the participant can bid a predetermined price for the auction commodity through the participant terminal to the auction terminal and transmit information of a hope of purchase of the commodity to be sold by the dealer. Accordingly, if the participant purchases the commodity to be sold by the dealer, then since part or all of the delivery charge for the commodity and/or the auction commodity is borne by the dealer, suppression of the delivery cost for the auction commodity to be borne by a personal seller or the participant can be anticipated, and activation of the auction can be anticipated.

Preferably, the auction server further has an information classification function for classifying the auction commodity information from the personal seller terminals based on the auction commodity information and classifying the dealer provision information including the dealer commodity information from the dealer terminal based on the dealer commodity information, and a link registration function for linking the auction commodity information and the dealer provision information based on the classifications by the information classification function, and the auction information transmission function transmits the auction commodity information and the dealer provision information linked to each other by the link registration function to the participant terminal.

Further preferably, the auction commodity information regarding each auction commodity includes information for specifying a classification of the auction commodity, and the dealer commodity information regarding the dealer commodity included in the dealer provision information includes information for specifying a classification of the dealer commodity.

With the auction system, auction commodity information and dealer provision information are classified based on the auction commodity information and dealer commodity information for example, based on a commodity name included in the auction commodity information and the dealer commodity information, and the information is linked to each other based on the classifications. Then, the information linked to each other is transmitted to a pertaining participant terminal. Consequently, a participant of the participant terminal can recognize that a commodity relating to the auction commodity is sold from a dealer, and therefore can purchase the dealer commodity relating to the auction commodity simultaneously upon bidding performed for the auction commodity. Therefore, the participant can purchase the dealer commodity and can readily utilize bearing of the delivery charge by the dealer. As a result, reduction of the delivery charge to be borne by the parties to the auction can be anticipated, and activation of the auction can be anticipated.

The auction system may be configured such that the auction server further has a delivery information reception storage function for receiving and storing distribution information of a plurality of predetermined distributors from distributor terminals owned by the distributors and connected to the auction server through the network, and the auction information reception storage function transmits, when auction commodity information is received from any of the personal seller terminals, the delivery information to the personal seller terminal and receives first distributor designation information which designates one of the distributors which is entrusted with delivery of the auction commodity by the personal seller while the dealer information reception storage function transmits, when auction commodity information is received from the dealer terminal, the delivery information to the personal seller terminal and receives second distributor designation information which designates one of the distributors which is entrusted with delivery of the dealer commodity by the dealer, the information classification function classifying the auction commodity information and the dealer provision information based on the first distributor designation information and the second distributor designation information.

With the auction system, an auction commodity and a dealer commodity are combined based on information of a distributor who is entrusted with delivery of the commodities, and are sold in the combined state. Accordingly, when a participant purchases commodities in combination, since the commodities are delivered by a single distributor, suppression of the delivery charge can be anticipated.

According to a further aspect of the present invention, there is provided an auction system, comprising a plurality of personal seller terminals and a plurality of participant terminals, and an auction server connected to the personal seller terminals and the participant terminals through a network, the auction server having an auction information reception storage function for receiving and storing auction commodity information from the personal seller terminals, an auction information transmission function for transmitting the auction commodity information to any of the participant terminals in response to a request from the participant terminal, and an auction function for receiving bidding information from the participant terminals based on the auction commodity information and determining a successful bidder based on the bidding information, the auction server further having a dealer information reception storage-function for receiving, from a dealer terminal owned by a predetermined dealer and connected to the auction server through the network, and storing dealer provision information including dealer commodity information which is information regarding a commodity to be sold by the dealer and delivery charge information which is information regarding the charge for delivery to be borne by the dealer in place of the person who purchases the dealer commodity, the auction information reception storage function transmitting, when auction commodity information is received from any of the personal seller terminals, the dealer provision information to the personal seller terminal, whereafter the auction information reception storage function issues a request to select one of commodities in the dealer commodity information included in the dealer provision information and desired to be sold together with the auction commodity by the personal dealer and then receives commodity selection information from the personal seller terminal transmitted thereto in response to the request, the auction information transmission function placing the commodity selection information into the information to be transmitted to the participant terminal, the auction function receiving purchase desired commodity information corresponding to thee commodity selection information transmitted from the participant terminals together with the bidding information.

With the auction system, when auction commodity information is transmitted from a personal seller terminal, dealer provision information is transmitted from the auction server to the personal seller terminal, Then, information of selection of a commodity which the personal seller hopes to sell together with the auction commodity based on the thus transmitted information, for example, based on dealer commodity information, is transmitted from the personal seller terminal to the auction server. The information of the combination is transmitted to each participant terminal. Consequently, the participant of the participant terminal can select a commodity to be purchased from among commodities combined with the auction commodity. Accordingly, since commodities which can be sold in combination with an auction commodity are set in advance and presented to each participant, the participant can selectively purchase one of the commodities thus combined. As a result, the opportunity in which each participant purchases an auction commodity and a dealer commodity in combination increases, and each participant can readily utilize bearing of the delivery charge of the dealer and suppression of the delivery cost for the auction commodity can be anticipated.

The commodity selection information may be information for selection of one commodity. In the auction system just described, since a commodity to be sold in combination with an auction commodity is set in advance, if the auction commodity and the dealer commodity are purchased, then since delivery charge is automatically borne by the dealer, augmentation of the convenience of the auction can be anticipated.

According to a still further aspect of the present invention, there is provided an auction system, comprising a plurality of personal seller terminals and a plurality of participant terminals, and an auction server connected to the personal seller terminals and the participant terminals through a network, the auction server having an auction information reception storage function for receiving and storing auction commodity information from the personal seller terminals, an auction information transmission function for transmitting the auction commodity information to any of the participant terminals in response to a request from the participant terminal, and an auction function for receiving bidding information from the participant terminals based on the auction commodity information and determining a successful bidder based on the bidding information, the auction server further having a dealer information reception storage function for transmitting the auction commodity information to a dealer terminal owned by a predetermined dealer and connected to the auction server through the network and receiving from the dealer terminal and storing dealer provision information including dealer commodity information which is information regarding a commodity to be sold by the dealer, auction commodity designation information which designates one of the auction commodities which the dealer hopes to be purchased together with the dealer commodity and delivery charge information which is information regarding the charge for delivery to be borne by the dealer in place of the person who purchases the dealer commodity, the auction information transmission function placing and transmitting the dealer provision information into and together with the information to be transmitted to the participant terminal.

With the auction system, auction commodity information is transmitted to a dealer terminal, and information which designates an auction commodity which the dealer wants to sell together with a commodity to be sold by the dealer is transmitted from the dealer terminal to the auction server. Then, information of the combination of the commodities is transmitted to each participant terminal. Accordingly, since an auction commodity and a dealer commodity combined in advance are sold, the opportunity in which the parties to the auction utilize bearing of the delivery charge by the dealer increases, and suppression of the delivery cost can be anticipated and activation of the auction can be anticipated.

Also in this instance, the auction commodity designation information is information which designates one of the auction commodities. This provides such an advantage as described above.

Each of the auction systems according to the second to fourth aspects of the present invention described above may be configured such that the auction server further has a delivery information reception storage function for receiving and storing distribution information of a predetermined distributor from a distributor terminal owned by the distributor and connected to the auction server through the network, and the auction information transmission function places and transmits the delivery information into and together with the information to be transmitted to the participant terminal while the auction function receives distributor designation information based on the delivery information from the participant terminal.

With the auction systems, information regarding each distributor is transmitted from the distributor terminal of the distributor to each participant terminal through the auction server. Then, the participant of the participant terminal transmits information which designates a distributor who is to be entrusted with delivery of a commodity purchased in the auction based on the information of the distributors from the participant terminal to the auction server, and the auction server receives the information. Accordingly, even when a participant purchases an auction commodity and a dealer commodity, since it can entrust a single distributor with the delivery of the commodities, further suppression of the delivery cost can be anticipated.

According to a yet further aspect of the present invention, there is provided an auction system, comprising a plurality of personal seller terminals and a plurality of participant terminals, an auction server connected to the personal seller terminals and the participant terminals through a network, and the auction server having an auction information reception storage function for receiving and storing auction commodity information from the personal seller terminals, an auction information transmission function for transmitting the auction commodity information to any of the participant terminals in response to a request from the participant terminal, and an auction function for receiving bidding information from the participant terminals based on the auction commodity information and determining a successful bidder based on the bidding information, a dealer terminal owned by a predetermined dealer and connected to the auction server through the network, the dealer terminal having a dealer information transmission function for transmitting dealer provision information including dealer commodity information which is information regarding a commodity to be sold by the dealer and delivery charge information which is information regarding the charge for delivery to be borne by the dealer in place of the person who purchases the dealer commodity to the auction server, the auction server further having a dealer information reception storage function for receiving and storing the dealer provision information, the auction information transmission function of the auction server placing and transmitting the dealer provision information into and together with the information to be transmitted to the participant terminal, each of the participant terminals having a bidding function for transmitting purchase desired commodity information corresponding to the dealer provision information to the auction server together with the bidding information, the auction function of the auction server receiving the purchase desired commodity information corresponding to the dealer provision information transmitted from the participant terminal together with the bidding information.

The auction system may be configured such that it further comprises a distributor terminal owned by a predetermined distributor and connected to the auction server through the network, and the distributor terminal has a delivery information transmission function for transmitting delivery information of the distributor to the auction server and the auction server has a delivery information reception storage function for receiving and storing the delivery information from the distributor terminal, the auction information transmission function of the auction server placing and transmitting the delivery information into and together with the information to be transmitted to the participant terminal, the bidding function of the participant terminal transmitting distributor designation information based on the delivery information to the auction server together with the bidding information and the purchase desired commodity information, the auction function of the auction server receiving the distributor designation information from the participant terminal.

According to a yet further aspect of the present invention, there is provided an auction program for causing an auction server connected to a plurality of personal seller terminals, a plurality of participant terminals and a dealer terminal owned by a predetermined dealer through a network to execute an auction information reception storage process for receiving and storing auction commodity information from the personal seller terminals, a dealer information reception storage process for receiving from the dealer terminal and storing dealer provision ;information including dealer commodity information which is information regarding a commodity to be sold by the dealer and delivery charge information which is information regarding the charge for delivery to be borne by the dealer in place of the person who purchases the dealer commodity, an auction information transmission process for transmitting the auction commodity information and the dealer provision information to any of the participant terminals in response to a request from the participant terminal, and an auction process for receiving bidding information from the participant terminals based on the auction commodity information and purchase desired commodity information corresponding to the dealer provision information and determining a successful bidder based on the bidding information.

According to an additional aspect of the present invention, there is provided a recording medium on which the auction program described above is stored.

In summary, according to the present invention, if a dealer commodity to be sold in combination with an auction commodity is purchased, then since part or all of the delivery charges for the commodities is borne by the dealer who sells the dealer commodity, such superior advantages that reduction of the delivery charge to be borne by the parties who sell and buy in the auction can be anticipated and that activation of the auction can be anticipated are achieved.

Further, since an auction commodity and a dealer commodity or commodities which relate to each other are displayed in combination, each participant can purchase a dealer commodity relating to the auction commodity simultaneously upon bidding performed for the auction commodity. Therefore, the participant can purchase the dealer commodity readily and can readily utilize bearing of the delivery charge by the dealer. As a result, reduction of the delivery charge to be borne by the parties to the auction can be anticipated, and activation of the auction can be anticipated.

Further, where a single distributor can be entrusted with delivery of an auction commodity and a dealer commodity, suppression of the delivery charge can be anticipated.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1(A) is a is a block diagram showing a configuration of an auction system to which the present invention is applied;

FIG. 1(B) is a block diagram illustrating functions of a server control section of an auction server of the auction system shown in FIG. 1(A);

FIG. 2 is a diagrammatic view illustrating a table of site user information from within a data base stored in the auction server shown in FIG. 1(A);

FIG. 3 is a diagrammatic view illustrating a table of auction commodity information from within the database stored in the auction server shown in FIG. 1(A);

FIG. 4 is a diagrammatic view illustrating a table of dealer information from within the database stored in the auction server shown in FIG. 1(A);

FIG. 5 is a diagrammatic view illustrating a table of dealer commodity information from within the database stored in the auction server shown in FIG. 1(A);

FIG. 6 is a diagrammatic view illustrating a table of distributor information from within the database stored in the auction server shown in FIG, 1(A);

FIG. 7 is a schematic view showing a user interface displayed on a participant terminal shown in FIG. 1(A);

FIG. 8 is a flow diagram illustrating operation of parties registered in the system shown in FIG. 1(A);

FIG. 9 is a sequence diagram illustrating operation of the system shown in FIG. 1(A); and

FIG. 10 is a similar view but illustrating operation of a modification to the system shown in FIG. 1(A).

### DESCRIPTION OF THE PREFERRED EMBODIMENT

Preferred Embodiment

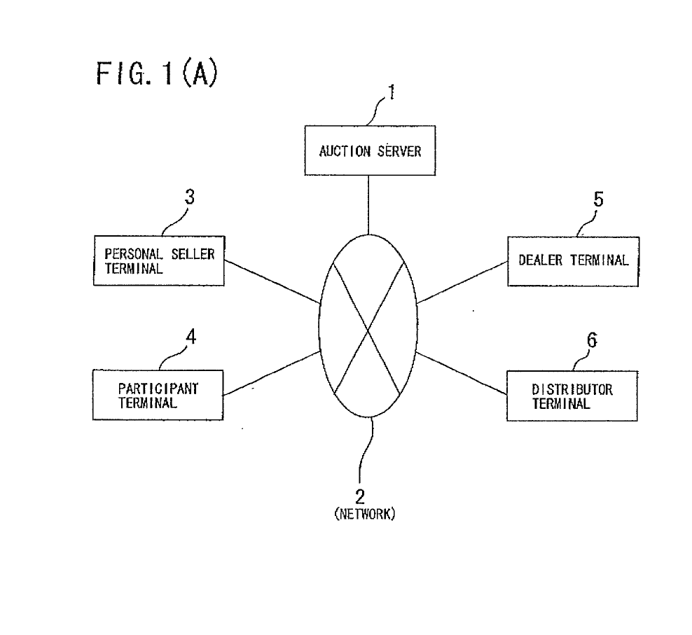

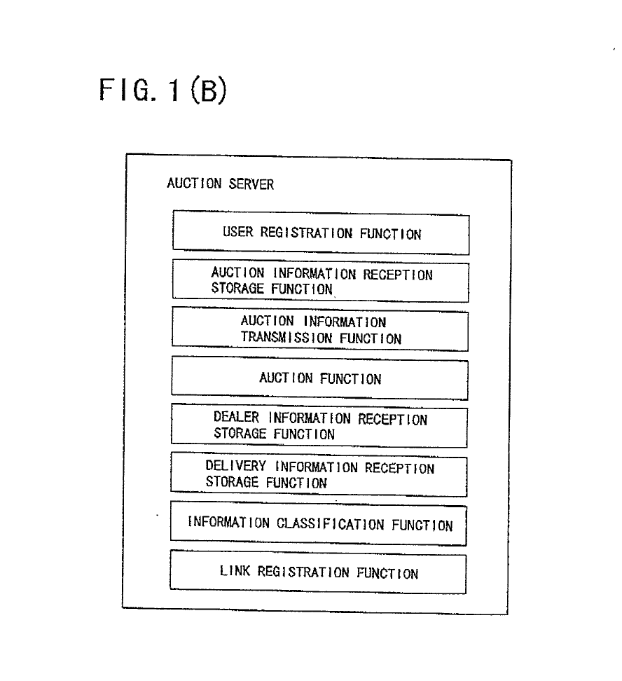

Referring first to FIG. 1(A), there is shown an auction system to which the present invention is applied. The network system utilizes a network 2 and includes an auction server 1 which holds an auction site. To the auction server 1, a plurality of personal seller terminals 3 (only one is shown) each owned by a personal seller who displays an auction commodity in the auction, a plurality of participant terminals 4 (only one is shown) each owned by a participant (purchaser) who tries to bid, a plurality of dealer terminals 5 (only one is shown) each owned by a commodity (dealer commodity or commodity for which the charge for delivery should be borne) which may be purchased by a participant together with such an auction commodity mentioned above, and a plurality of distributor terminals 6 (only one is shown) each owned by a distributor who distributes a commodity transacted in an auction are connected through the network 2.

The terminals 3, 4, 5 and 6 described above can access the auction site formed by the auction server 1, and information necessary for an auction such as personal information and commodity information is inputted from the terminals 3, 4, 5 and 6 to the auction site so that a database is constructed in the auction server 1. Different pieces of information in the database are linked such that information necessary for each transaction is combined Predetermined processing is performed by the auction server 1 based on the information of the database to perform an auction of a commodity. An auction is performed in this manner.

First, general operation of the auction system is described.

General Operation

First, site users (personal sellers or participants) register their personal information such as an address or a name. Further, each personal seller registers, as information relating to a commodity to be displayed in an auction when the auction commodity (commodity for auction) is to be sold, a category, a size, a weight, sales conditions and so forth of the commodity. Here, if the personal seller wants to sell the auction commodity in a combination display (a display method wherein an auction commodity and a commodity to be sold by a dealer are sold in combination), then the auction commodity is coordinated with the dealer commodity.

Also each dealer similarly registers basic information such as an address and a company name as dealer information in advance and registers dealer commodity information into a table. Then, as regards a commodity to be displayed in a combination display, it is coordinated with an auction commodity. Further, also a table in which a ratio at which the charge for delivery is to be borne with regard to a commodity to be displayed by a personal seller is registered is constructed in the database. Here, the bearing of the charge for delivery signifies that, when a dealer commodity is purchased in combination with an auction commodity, the dealer bears the charge for delivery. For example, if a dealer commodity or commodities are purchased by more than 5,000 yen, then the charge for delivery for the auction commodity or commodities is borne by up to 500 yen by the dealer.

Consequently, a participant who purchases an auction commodity and a dealer commodity in combination has part or all of the charge for delivery of the purchased commodities borne by the dealer.

In the following, the auction system is described in more detail.

Auction Server

The auction server 1 is a server computer managed by a dealer who administrates an auction using the network 2. The auction server 1 executes a server program stored on a recording medium such as a CD-ROM so that it operates as a Web site which provides predetermined contents. The auction server 1 includes a server control section which arithmetically operates predetermined information from the other terminals on the network 2 and controls operation of the entire auction Server 1, and a server storage section having a predetermined storage capacity. In particular, the server control section is a central processing unit (CPU), and the server storage section is a storage medium such as a hard disk.

The auction server 1 holds an auction site as a Web site to perform an auction on the network. In particular, the server control section of the auction server 1 is provided with functions necessary to perform an auction, and the server storage section has a database constructed therein which includes a plurality of information tables necessary for the auction.

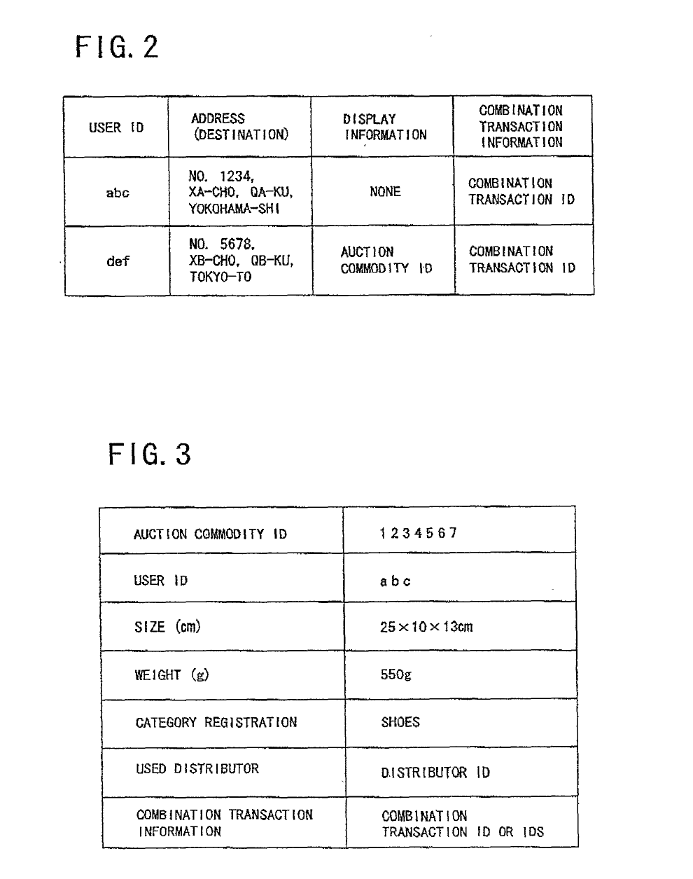

The database includes five tables (refer to FIGS. 2 to 6) for site users (personal dealers and participants), dealers (sales traders) who sell commodities on the network, distributors, commodities (auction commodities) displayed in the auction and commodities (dealer commodities) sold by the dealers. In the database, pieces of information relating to the users such as, for example, pieces of information of dealers and dealer commodities, are coordinated with and linked to each other. In the following, information in the tables is described.

FIG. 2 illustrates the table for site user information. Referring to FIG, 2, both of participants and personal sellers are registered as site users in the table. The information of the table includes a user ID, personal information necessary for calculation of the charge for delivery such as an address, display information if a commodity is displayed in the auction, and combination transaction information if another commodity is to be sold in combination with the displayed commodity.

FIG. 3 illustrates the table for auction commodity information. Referring to FIG. 3, the table includes information of an auction commodity ID, a user ID of a personal seller (displaying person) of the commodity, and a size, a weight and a category registration as attribute information of the commodity. Further, if the commodity is a combination display, then the information further includes combination transaction information. If a plurality of combination commodities are involved, the combination transaction information includes a plurality of combination transaction IDs.

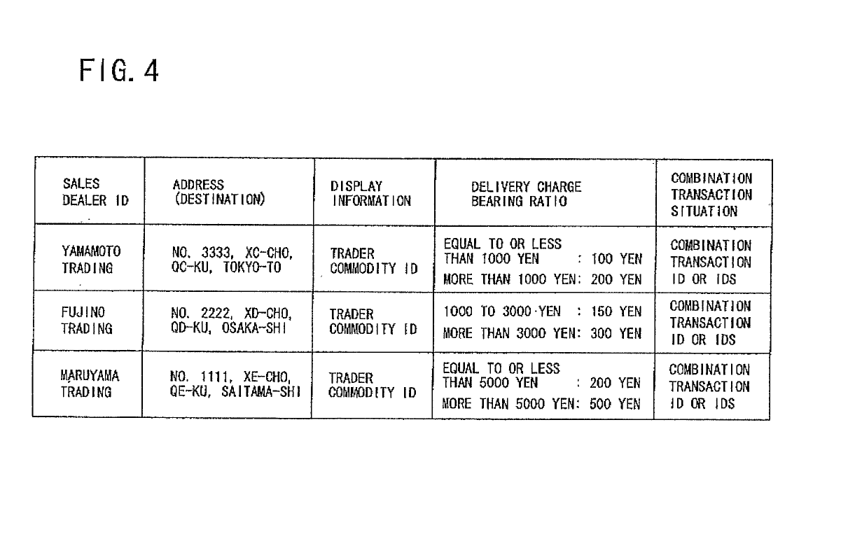

FIG. 4 illustrates the table for dealer information. Referring to FIG. 4, the table stores a dealer ID, address information necessary for calculation of the charge for delivery, a dealer commodity ID of a commodity (dealer commodity)displayed for combination, a bearing ratio of the charge for delivery of the combination commodity to be purchased, and a combination transaction ID currently in transaction.

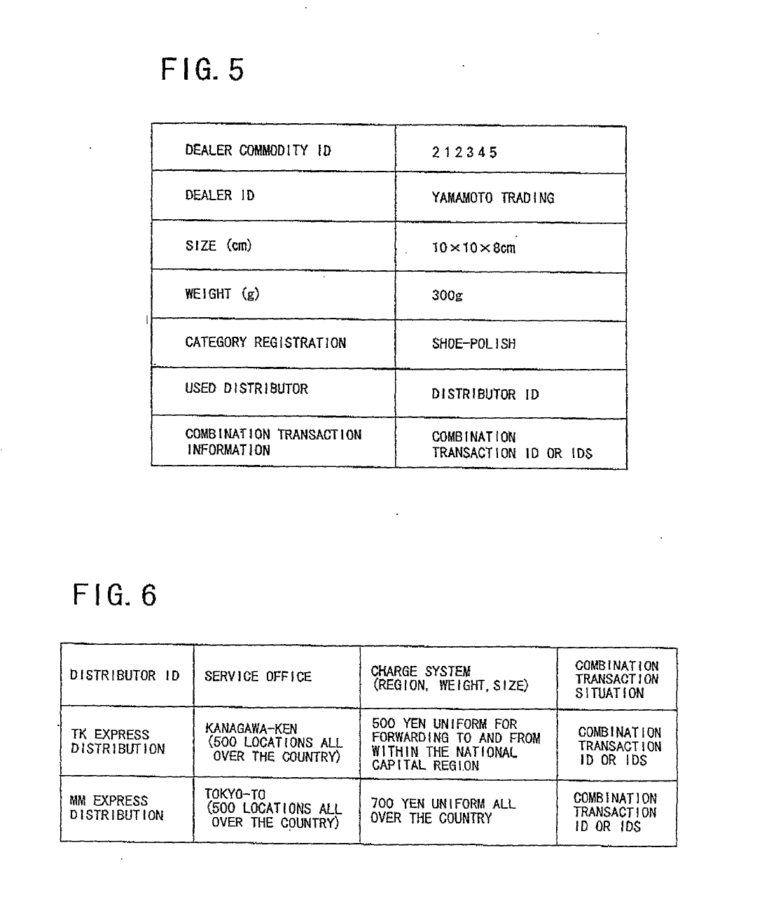

FIG. 5 illustrates the table for dealer commodity information. Referring to FIG. 5, the table includes information of a dealer commodity ID, a dealer ID of the commodity, and a size, a weight and a category registration as attribute information of the commodity. Where the commodity is a combination display, the table additionally includes combination transaction information.

FIG. 6 illustrates the table for distributor information. Referring to FIG. 6, the table stores information of a distributor ID, a location and a distribution area of a service office of a distribution lodgment, and a charge system wherein the charge depends upon the size, the weight and so forth. Also a combination transaction ID for confirmation of a transaction situation of a combination commodity is stored in the table.

Here, various functions of the server control section of the auction server 1 are described. Referring to FIG. 1(B), the server control section has a user registration function for registering a displaying person in or a participant to an auction or the like, an auction information reception storage function for receiving and storing auction commodity information from the personal seller terminals 3, an auction information transmission function for transmitting auction commodity information to a participant terminal 4 in response to a request from the participant terminal 4, and an auction function for receiving bidding information from the participant terminals 4 based on the auction commodity information and determining a successful bidder based on the bidding information.

The server control section further has a dealer information reception storage function for receiving, from any of the dealer terminals 5 each owned by a predetermined dealer and connected to the auction server 1 by the network 2, and storing dealer provision information including dealer commodity information which is information regarding a commodity to be sold by the dealer and delivery charge information which is information regarding the charge for delivery to be borne by the dealer in place of a person who purchases the dealer commodity, a delivery information reception storage function for receiving and storing distribution information of distributors from the distributor terminals 6 of the distributors, an information classification function for classifying auction commodity information from the personal seller terminals 3 based on the auction commodity information and classifying dealer provision information including dealer commodity information from the dealer terminals 5 based on the dealer commodity information, and a link registration function for linking the auction commodity information and the dealer provision information based on the classifications by the information classification function. In the following, the functions mentioned are individually described in detail,

The user registration function performs user registration so that, when a general user who desires to display an auction commodity or purchase (bid) some other auction commodity in an auction uses a terminal of the user itself to access the auction site, the general user can utilize the site. More particularly, the user registration function first requests the general user for information of an address, a mail address and so forth. Then, the user registration function issues a user ID which is information for identification and issues a password for confirmation of the user who accesses the site. Then, the user registration function stores the information from the user into the server storage section together with the user ID to produce such a site user information table as illustrated in FIG. 2.

The auction information reception storage function receives such display information as described above, that is, information (auction commodity information) regarding all auction commodity to be displayed by a personal seller, from its personal seller terminal 3 and stores the information into the server storage section. In this instance, an auction commodity ID is allocated to the auction commodity information as described above, and particulars of the same are stored into such a table as illustrated in FIG. 3. Further, the information is linked to the user (personal seller) illustrated in FIG. 2 based on the auction commodity ID,

Further, the auction information reception storage function transmits, when it receives auction commodity information from a personal seller terminal 3, dealer provision information to the personal seller terminal 3 and issues a request to select one of commodities in the dealer commodity information included in the dealer provision information and desired to be sold together with the auction commodity by the personal dealer. Then, the auction information reception storage function receives commodity selection information from the personal seller terminal 3 transmitted in response to the request. Accordingly, the auction server 1 receiving the information enters an ID of the sales commodity to be combined into a place for the combination transaction information illustrated in FIG. 2 based on information from the personal seller who desires to sell its sales commodity by combination sales with the auction commodity to register the sales commodity. Here, the commodity selection information which is information that the personal seller selects a commodity to be sold in combination may be information for selection of a plurality of commodities or information for selection of a single commodity.

The dealer information reception storage function receives, from a dealer terminal 5, such information of the dealer and so forth as described above with reference to FIGS. 3 and 4 and stores the received information into the server storage section. At this time, a unique ID is provided to each of dealer commodities (delivery charge bearing object commodities) to be sold by the dealer, and detailed information of each of the dealer commodities is coordinated with the dealer.

Further, the dealer information reception storage function receives and stores dealer provision information including auction commodity information transmitted from the auction server 1 to a dealer terminal 5 in advance and auction commodity designation information which is transmitted from the dealer terminal 5 based on the auction commodity information and designates an auction commodity which the dealer desires to be purchased together with a dealer commodity. In other words, the dealer can designate an auction commodity to be sold in combination with a sales commodity sold by the dealer itself. Here, the auction commodity designation information which designates an auction commodity to be sold in combination may designate selection of a plurality of commodities or of a single commodity.

The delivery information reception storage function receives such delivery information as described with reference to FIG. 6 from a distributor terminal 6 and stores the received delivery information. If a personal seller or a dealer entrusts a particular distributor with delivery of a commodity sold by itself, then the auction commodity information or the dealer commodity information includes distributor information (ID), and the delivery information includes the commodity information as combination transaction information. In other words, a distributor and an auction commodity or a dealer commodity are coordinated with each other.

The information classification function classifies auction commodity information and dealer provision information based on information of a commodity name of a commodity and so forth included in the auction commodity information and the dealer commodity information. For example, if the auction commodity is “shoes” and the dealer commodity is a “shoe-horn”, then the two commodities are classified so that they may belong to the same class.

The link registration function links pieces of information, which include commodities discriminated to belong to the same class, to each other. In particular, information which specifies that information in which commodities linked to each other are included is placed in the combination transaction ID illustrated in FIG. 2 and so forth. An auction commodity or commodities and a dealer commodity or commodities are combined in this manner.

The auction information transmission function transmits auction commodity information stored in the server storage section to a participant terminal 4 having a user registration in the auction server 1 when the participant terminal 4 accesses the auction site and requests the auction site for information of auction commodities. In this instance, for example, the auction site includes a search engine for auction commodities and searches for a commodity desired to be purchased by the participant terminal 4. Then, if the participant requests the auction site to access the searched out commodity information, then the auction commodity information is transmitted to the participant terminal 4 by the auction information transmission function. At this time, also dealer provision information including information of sales commodities to be sold by dealers is transmitted to the participant terminal 4. The dealer provision information to be transmitted in this instance is information of a particular dealer commodity or commodities linked to the auction commodity of an object of the request of the participant by the link registration function described above.

Further, where an auction commodity and a dealer commodity are combined with each other in advance by a personal seller or a dealer as described hereinabove, the auction information transmission function transmits auction commodity information and dealer provision information which include information relating to the auction commodity or dealer commodity based on the combination to the participant terminal 4.

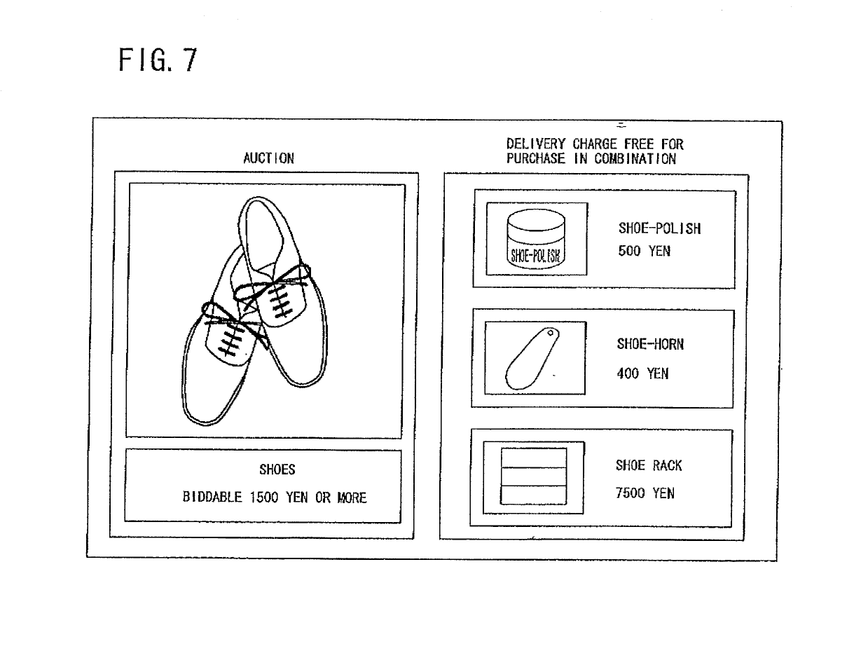

An example of information transmitted to the participant terminal 4 by the auction information transmission function is described with reference to FIG. 7. FIG. 7 shows a screen displayed on a display unit of the participant terminal 4. Referring to FIG. 7, the left side half of the display screen indicates information of an object of request for accessing as a result of search of the auction site by a participant, that is, information regarding an auction commodity. In the example shown in FIG. 7, the auction commodity is “shoes”, and also the lowest bid price is displayed. Meanwhile, on the right half side of the display screen of FIG. 7, dealer commodities linked to the “shoes” of the auction commodity are displayed. Consequently, when a participant tries to bid the auction commodity, it can take also purchase of a commodity (dealer commodity) linked to the auction commodity into consideration. Further, if the participant purchases a dealer commodity, then since a predetermined delivery charge is borne by the dealer of the dealer commodity, the participant can anticipate suppression of the delivery cost of the commodity purchased in the auction.

Here, the auction information transmission function may place and transmit the delivery information into and together with the information to be transmitted to the participant terminal 4. The delivery information is information relating to delivery of a distributor described hereinabove with reference to FIG. 6. Consequently, a participant can designate a distributor whose delivery charge is less expensive as well.

The auction function receives bid information for a commodity from the participant terminals 4 and compares the bid prices of the received bid information for the commodity with one another to determine that participant which has exhibited the highest bid price as a successful bidder for the auction commodity. After the determination of the successful bidder, the auction function notifies, for example, the participant terminal 4 of the successful bidder and the personal dealer terminal 3 of the contract price and mutual contact addresses of them. Further, the auction function receives purchase desired commodity information corresponding to dealer provision information transmitted together with the bid information from the participant terminal. In particular, such an auction commodity and a dealer commodity or commodities as shown in FIG. 7 are transmitted to the participant terminal 4 as described hereinabove, and if the participant hopes to purchase the dealer commodity or any of the dealer commodities together with the bidding, then the information of the hope of the purchase is transmitted from the participant terminal 4 and received by the auction function.

Further, the auction function may receive distributor designation information based on delivery information from a participant terminal 4. This is a function of receiving information that a distributor to be entrusted with delivery of a commodity purchased by a participant is designated and determining a distributor by which the commodity should be delivered.

The functions of the server control section of the auction server 1 described above can be implemented by the control section (CPU) executing programs for the individual functions, that is, an auction program in which a network is employed. For example, the auction program includes sub programs for causing the auction server 1 connected to the personal seller terminals 3, participant terminals 4 and the dealer terminals 5 of predetermined dealers by the network 2 to execute an auction information reception storage process for receiving and storing auction commodity information from a personal seller terminal 3, a dealer information reception storage process for receiving from a dealer terminal 5 and storing dealer provision information including dealer commodity information which is information relating to a commodity or commodities to be sold by the dealer and delivery charge information which is information regarding a delivery charge to be borne by the dealer in place of a person who purchases the dealer commodity, an auction information transmission process for transmitting auction commodity information and dealer provision information to a participant terminal 4 in response to a request from the participant terminal 4, and an auction process for receiving bid information based on auction commodity information from the participant terminals 4 and purchase desired commodity information corresponding to dealer provision information and determining a successful bidder based on the bid information. The auction program is read out from a medium which can be carried such as a CD-ROM or downloaded from some other computer on the network 2 and installed into the auction server 1.

<Network>

The network 2 is the Internet wherein a dedicated line, a telephone network, a cable of a CATV or the like is used to perform communication in accordance with the TCP/IP protocol. However, the network 2 may otherwise be an intra-network which operates in a particular organization or some other particular network wherein some other protocol than the TCP/IP protocol is used for communication.

<Personal Seller Terminal>

The personal seller terminal 3 is a terminal (user terminal) owned by a personal seller who displays an auction commodity in the a auction system which employs a network according to the present invention. The personal seller terminal 3 clan be connected to the network 2 and has predetermined communications means and a communication function. For example, the personal seller terminal 3 is a personal computer having a processing section having a predetermined processing capacity and a storage section having a predetermined storage capacity and further including basic components of a computer such as a display section such as a display unit and an inputting section such as a keyboard and/or a rouse. However, the personal seller terminal 3 is not limited to the personal computer but may be a portable information terminal such as a portable telephone set or an electronic notebook.

The personal seller terminal 3 has an access function for accessing the auction site held on the auction server 1 and a function for transmitting and receiving predetermined information to and from the auction site. The personal seller terminal 3 can use the functions mentioned to transmit and receive various kinds of information to and from the auction server 1 as described above.

<Participant Terminal>

The participant terminal 4 is a terminal (user terminal) owned by a person who participates in an auction on the network and performs bidding for an auction commodity displayed in the auction. Here, the participant may be a personal seller described above. In other words, the participant may display an auction commodity and bid for some other auction article.

The participant terminal 4 is a terminal which can be connected to the network 2 such as a personal computer similarly to the personal seller terminal 3 described above. The participant terminal 4 can transmit and receive various kinds of information to and from the auction server 1.

<Sales Trader Terminal>

The dealer terminal 5 is a terminal owned by a dealer who sells not an auction commodity but a commodity handled by the dealer (that is, a dealer commodity or a delivery charge bearing object commodity). In particular, the dealer registers a dealer commodity or commodities into the auction site so as to be purchased, by a participant who purchases an auction commodity, together with the auction commodity in the auction and requests the auction site to exhibit the dealer commodity or commodities. Thereafter,. the dealer commodity or commodities are displayed. Then, the dealer bears part or all of the delivery discharge of the auction commodity and the dealer commodity or commodities for the participant who purchases the dealer commodity or commodities in combination with the auction commodity.

The dealer terminal 5 is a terminal which can be connected to the network 2 such as a personal computer similarly to the personal seller terminal 3 described hereinabove. The dealer terminal 5 can transmit and receive various kinds of information to and from the auction server 1.

<Distributor Terminal>

The distributor terminal 6 is a terminal owned by a distributor who distributes an auction commodity or a dealer commodity sold or purchased in an auction on the network. The distributor is designated by a participant after determination of purchase of a commodity or by a personal seller or a dealer when a commodity is displayed.

The distributor terminal 6 is a terminal which can be connected to the network 2 such as a personal computer similarly to the personal seller terminal 3 described hereinabove. The distributor terminal 6 can transmit and receive various kinds of information to and from the auction server 1.

<Operation>

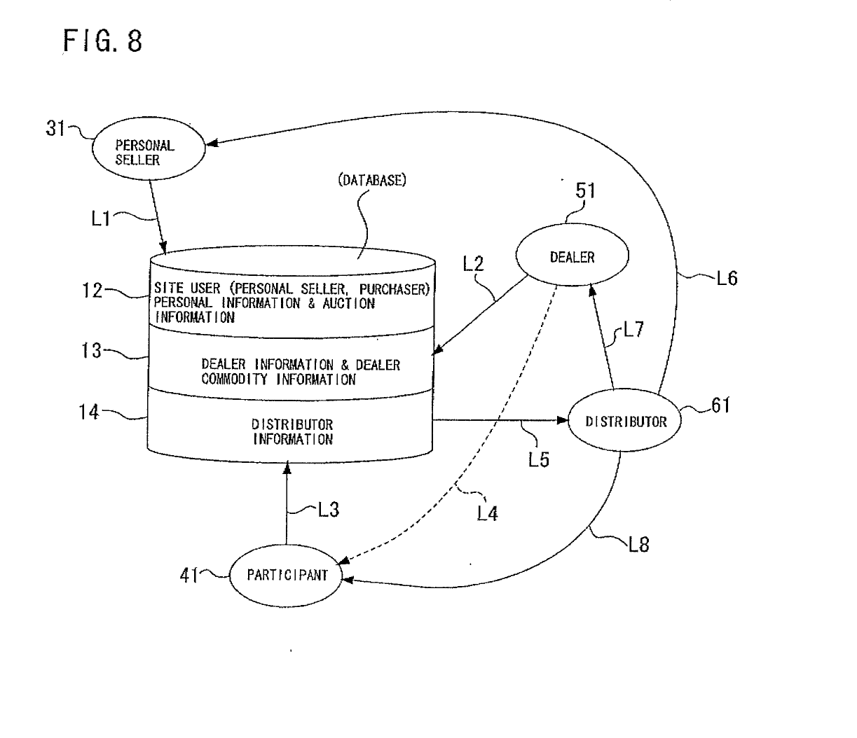

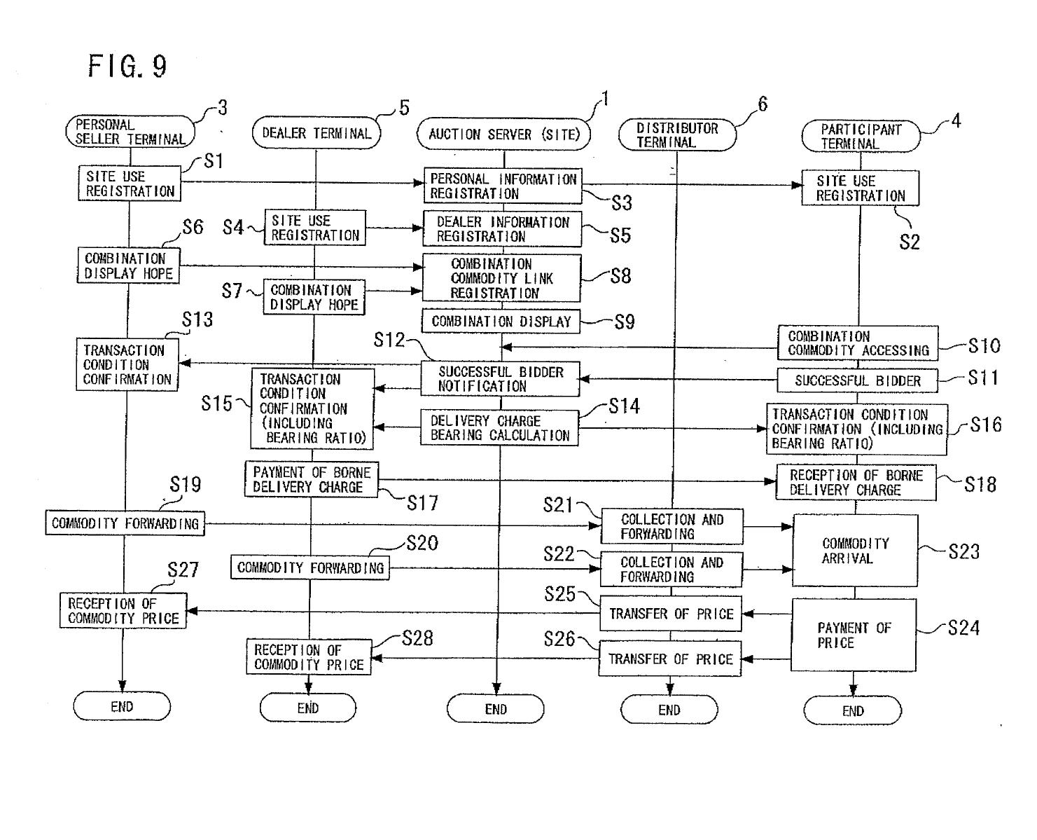

Now, operation of the auction system described above is described in detail with reference to FIGS. 8 and 9. FIG. 8 illustrates operation of a person who registers into the system, and FIG. 9 illustrates operation of the terminals 3, 4, 5 and 6 of the system. It is to be noted that the user ID of a participant 41 is “abc”; the user ID of a personal seller 31 is “def”; the dealer ID of a dealer 51 is “Maruyama Trading”; and the distributor ID of a distributor 61 is “TK Express Distribution” or “MM Express Distribution”.

First, as preparations in advance, each of site users (the participant 41 and the personal seller 31) accesses the auction server (site) 1 to perform site use registration so that it can thereafter use the auction site. In this instance, the personal seller 31 transmits its user ID (for example, “abc”) and address (for example, “No. 1234, Xa-cho, Qa-ku, Yokohama-shi”) as personal information to be placed into a table described hereinabove with reference to FIG. 2 from the personal seller terminal 3 to the auction server 1 (step S1). Then, the auction server 1 receiving the personal information produces a site user table 12 in the database 11 provided in the server storage section of the auction server 1 and registers the personal information as the table 12 of the site user into the database 11 (step S3). This similarly applies to any other site user (the participant 41) (steps S2 and S3).

Further, in this instance, the personal seller 31 transmits information (refer to FIG. 3) regarding an auction commodity, which is a commodity to be displayed in an auction, to the auction server 1 (L1). The information received by the auction server 1 is registered into the database 11 in a linked relationship to the information (refer to FIG. 2) of the site user.

Similarly, the dealer 51 transmits its dealer ID (for example, “Maruyama Trading”) and address (for example, “No. 1111, Xe-cho, Qe-ku, Saitama-shi”) as company information and a dealer commodity ID as information of a commodity to be displayed from the dealer terminal 5 to the auction server 1 so as to be registered into such a table as described hereinabove with reference to FIG. 5 (step S4, L2). In this instance, also information regarding a delivery charge bearing ratio as delivery charge information (for example, information that “200 yen is borne if a commodity or commodities whose price is lower than 5,000 yen are purchased, but 500 yen is borne if a commodity or commodities whose price is equal to or higher than 5,000 yen are purchased” is transmitted. The auction server 1 receiving the information produces a table 13 regarding trader information in the database 11 and registers the information into the database 11 (step S5). This similarly applies to any other dealer.

Further, the distributor 61 transmits information regarding delivery (such as company information and a delivery charge) to be registered into such a table as described hereinabove with reference to FIG. 6 from the distributor terminal 6 to the auction server 1 so that a table 14 of the information may be registered into the database 11 in a similar manner as described above.

Then, if the personal seller 31 or the dealer 51 hopes to sell some commodity in combination with a commodity to be displayed by itself, it transmits its display hope to the auction server 1 (step S6 or S7). In particular, when the personal seller terminal 3 displays its auction commodity, dealer commodity information is transmitted to the personal seller terminal 3, and the personal seller 31 selects a combination commodity based on the information. This similarly applies to the dealer 51. Such combination display hopes from the personal seller 31 and the dealer 51 are received by the auction server 1.

Thereafter, combination transaction IDs for the combination commodities from the table 13 of trader information and the table 12 of the site user are added to the pertaining tables (refer to FIGS. 2 to 5) to establish a link between the auction display commodity (auction commodity) and the dealer commodity or commodities (step S8). Thereafter, the displaying preparations of the auction are completed and the commodities are displayed (step S9).

If information that a commodity should be sold in combination in advance is not available as in step S6 or S7, then linkage based on commodity names by the link registration function or the like described hereinabove may otherwise be performed. However, such linkage need not necessarily be performed.

Then, the participant 41 accesses the auction site from the participant terminal 4 of itself and requests the auction site for accessing to auction commodities (step S10). Then, in response to the request, information of the auction commodities and the dealer commodities is transmitted from the auction server 1 to the personal seller terminal 3. The auction site includes a system for searching for an auction commodity, and the participant 41 can search for an object commodity. Such search can be performed from both of the dealer commodities and the auction commodities. As regards combination commodities, commodities combined in advance by the personal seller 31 or the like or commodities classified in the same category are displayed on the display screen of the personal seller terminal 3.

For example, an example wherein the auction site executes a category search is described. If desirable commodities are searched out and selected from within a category of the auction site by the search described above, then such a display screen as shown in FIG. 7 is displayed on the participant terminal 4. In the screen display of FIG. 7, the search category is “shoes”, and shoes as an auction commodity in the currently proceeding auction are displayed on the left side half of the display screen. Further, a plurality of commodities relating to the “shoes” as the dealer commodity are displayed in a form combined with the auction commodity on the right side half of the display screen. The combination commodities are displayed based on the linkage established between the auction commodity table and the dealer commodity table in the database 11 as described above.

Then, the participant 41 whose user ID is “abc” accesses the auction commodity “shoes” and the dealer commodity “shoes rack” shown in FIG. 7 (step S10) and bids for the “shoes”. It is assumed that the participant 41 becomes a successful bidder of the auction commodity (step S11, L3). Particularly, it is assumed that the participant 41 becomes a successful bidder of the auction commodity “shoes” for 2,000 yen and purchases the dealer commodity “shoes rack” for 7,500 yen. It is to be noted that the delivery charge for the dealer commodity is included in the commodity price. Since the procedure and processing until the sales price is determined in the auction do not have a direct relationship to the present invention, description of them is omitted herein.

Then, the auction regarding the “shoes” displayed by the personal seller 31 of “abc” comes to an end with the determination of the successful bidder, and upon the ending, a successful bidder determination notification is sent from the auction server 1 to the dealer 51 of “Maruyama Trading” and the personal seller 31 of “abc” (step S12). In this instance, the personal seller 31 receives the successful bidder determination notification from the auction site (step S12) and confirms the transaction information (step S13). Meanwhile, the dealer 51 receives the successful bidder determination notification (step S12) and a result of delivery charge bearing calculation (step S14) performed by the auction site from the auction site and confirms the transaction information (including the delivery charge bearing ratio) (step S165).

In the example described, the delivery charge bearing ratio of the dealer 51 is 500 yen because the price of the show rack of “Maruyama Trading” of the dealer 51 is 7,500 yen (refer to FIG. 4). In other words, from within the delivery charge required for the delivery of the auction commodity and the dealer commodity, the dealer 51 bears 500 yen. In this instance, since the addresses of the participant 41 of “abc” who purchases the commodities and the personal seller 31 of “def” who displayed the auction commodity are in a national capital region, the delivery charge required where the distributor “TK Express Distribution” is used is 500 yen (refer to FIG, 6).

Thereafter, transfer of the commodities is performed actually. The delivery charge to be paid back to the participant 41 may be paid by a method wherein it is received when the dealer commodity is shipped. For example, a notification of a result of the delivery charge bearing calculation (step S14) is sent from the auction site to the participant 41 of “abc”, and the participant 41 confirms the transaction conditions (step S16). Then, the dealer 51 of “Maruyama Trading” pays the amount of money corresponding to the delivery charge to be borne thereby to the participant 41 of “abc” (steps S17 and S18, L4).

Then, the personal seller 31 of “def” forwards the auction commodity “shoes” (step S19). Meanwhile, the dealer 51 of “Maruyama Trading” forwards the auction commodity “shoes rack” (step S20). The distributor 61 of “TK Express Distribution” collects the auction commodity “shoes” of the personal seller 31 of “def” (L6) and distributes it to the participant 41 of “abc” (step S21). Meanwhile, the other distributor 61 of “MM Express Distribution” collects the dealer commodity “shoes rack” of the dealer 51 of “Maruyama Trading” (L7) and forwards it to the participant 41 of “abc” (step S22, L8). Here, the forwarding of the commodity by the distributor 61 is performed in accordance with a designation of the distributor 61 from the auction server 1 (L5),

Thereafter, the commodities arrive at the participant of “abc”, and the participant 41 accept the articles (step S23), Then, the prices for the commodities are paid by a payment-on-delivery method to the distributors 61 of “TK-Express Distribution” and “MM Expression Distribution” (steps S25 and S26). In other words, the participant 41 receiving the commodities pays the prices in exchange for the commodities to the distributor 61 (step S24). Then, from the distributor 61 of “TK Expression Distribution” to the personal seller 31 of “def”, the price for the pertaining commodity is paid, and from the distributor 61 of “MM Express Distribution” to the dealer 51 of “Maruyama Trading”, the price for the pertaining commodity is paid. Consequently, the personal seller 31 and the dealer 51 can acquire the prices for the respective commodities sold therefrom (steps S27 and S28).

Through the procedure described above, a participant in an auction can purchase an auction commodity displayed in the auction from a personal seller in combination with a dealer commodity from a dealer. Then, the dealer from which the commodity sold thereby is purchased bears part or all of the charges for delivery of the auction commodity and the dealer commodity Accordingly, in a transaction by an individual which occupies a great part of transactions in an auction system which employs a network, reduction of the charge for delivery to be borne between parties can be anticipated, and surplus disbursement other than that for transaction of a commodity can be suppressed. Furthermore, activation of the auction can be anticipated.

Here, detailed operation when the personal seller 31 selects a dealer commodity to be sold in combination with an auction commodity in advance is described. In other words, description is given of a detailed procedure wherein, when the personal seller 31 registers an auction commodity into the auction site from the personal seller terminal 3 in advance, it selects a dealer commodity to be combined from a list of dealer commodities.

In this instance, a method wherein a commodity to be sold in combination is determined from a category or another method wherein a commodity to be sold in combination is determined depending upon the amount of money can be used. The personal seller 31 who has selected a dealer commodity to be sold in combination with an auction commodity issues a notification of the selection to the auction site. Then, the auction site notifies the dealer 51 who displays the dealer commodity of the fact that it has been notified of reception of the combination displaying hope. Thereafter, the dealer 51 notifies the a auction site that it has accepted the combination display, whereby the combination display is established.

As another example, detailed operation when the dealer 51 selects an auction commodity which it hopes to sell in combination with a dealer commodity in advance is described.

In this instance, the dealer 51 registers auction commodity conditions for combination display into the auction site in advance. The dealer 51 registers such conditions as, for example, “the category is a skirt; the upset price is 3000 yen; and the delivery destination area is a national capital region”. Then, at a point of time when the auction commodity is registered into the auction site by the personal seller 31, a link in the database to the auction commodity which satisfies the conditions is established, that is, the dealer commodity and the auction commodity are coordinated with each other, thereby establishing combination display.

Modification

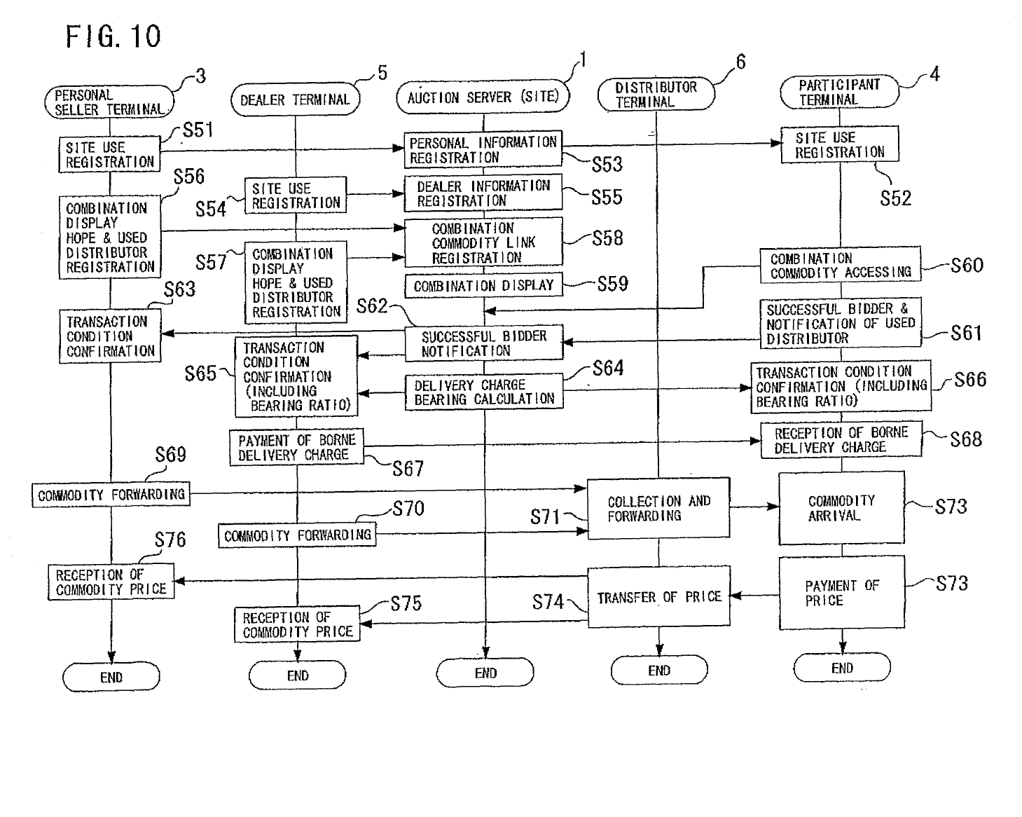

The auction system described above may be modified in the following manner, and the modified auction system operates in such a manner as illustrated in FIG. 10.

<Configuration>

The modified auction system is different from the auction system described above in that the auction server 1 additionally has a delivery information reception storage function for receiving and storing delivery information of a predetermined distributor 61 connected to the auction server 1 by the network 2 from a distributor terminal 6 owned by the distributor 61. Further, the auction information reception storage function transmits, when it receives auction commodity information from a personal seller terminal 3, delivery information to the personal seller terminal 3, and receives first distributor designation information for designating a distributor 61 to be entrusted with delivery of the auction commodity. The 1 dealer information reception storage function transmits, when it receives dealer provision information from a dealer terminal 5, delivery information to the dealer terminal 5 and receives second distributor designation information for designating a distributor 61 to be entrusted with delivery of a dealer commodity. The information classification function classifies auction commodity information and dealer provision information based on the first distributor designation information and the second distributor designation information.

The auction information reception storage function and the seller information reception storage function first transmit information (delivery information) regarding the distributors 61 which have registered into the auction site in advance to the personal seller 31 and the dealer 51. Each of the personal seller 31 and the dealer 51 receiving the delivery information determines, based on the information regarding the distributors 61, a distributor 61 to be entrusted with delivery of the commodity (auction commodity or dealer commodity) to be sold thereby. Further, each of the personal seller 31 and the dealer 51 uses its terminal 3 or 5 to transmit information (first or second distributor designation information) designating the determined distributor 61. Then, the auction information reception storage function and the seller information reception storage function receive and store the information transmitted from the personal seller 31 and the dealer 51, respectively. At this time, the information regarding the distributor 61 for each of the commodities described above is registered (used distributor of FIG. 3 or 5).

The information classification function classifies information relating to auction commodities and dealer commodities (auction commodity information and dealer provision information) based on the distributor 61 which delivers the commodities. In other words, the information classification function classifies the information based on the first and second distributor designation information described above. For example, the information classification function classifies commodities of the same distributor 61 into the same class. Alternatively, the information classification function may classify commodities based on some other information such as a delivery area of the distributor 61.

<Operation>

Now, operation of the modified auction system is described.

First, similarly as in the operation of the auction system described hereinabove, registration of site users and so forth is performed (steps S51 to S55). Then, when each of the personal seller 31 of “def” and the dealer 51 of “Maruyama Trading” issues a combination displaying home, it performs also registration of the distributor 61 of “MM Express Distribution” to been trusted with delivery of the commodity (step S56 or S57). Then, the auction site receiving the registrations performs combination of the commodities based on the delivery methods (for example, the used distributors) of the auction commodity and the dealer commodity (step S58). In the present modification, an auction commodity and a dealer commodity for which a common distributor is used are displayed in combination.

Then, similarly as in the operation of the auction system described above, bidding by the participants 41 and determination of a successful bidder are performed, and to that participant 41 which purchases also a dealer commodity, the delivery charge is paid back from the dealer 51 (steps S59 to S68).

Thereafter, the commodities (auction commodity and dealer commodity) purchased by the participant 41 are collected by the distributor 61 of “MM Express Distribution” and delivered to the participant 41 (steps S69 to S76).

With the modified auction system, since commodities for which a common distributor 61 is used are displayed in combination in advance, even if the sales sources of the commodities are different, they are delivered by the single distributor 61. Accordingly, efficient delivery can be anticipated, and further suppression of the delivery cost can be anticipated.

While, in the modified auction system, commodities for which the same distributor 61 is used are displayed in combination, they need not necessarily be displayed in combination. In particular, the auction information transmission function may include and transmit distribution information into and together with information to be transmitted to the participant terminal 4, and the auction function may receive distributor designation information based on the delivery information from the participant terminal 4.

Thus, when the participant 41 of “abc” purchases commodities in combination, it notifies the auction site of the distributor 61 of “MM Express Distribution” which is to be entrusted with the delivery by the participant 41 (step S61). The auction site receiving the notification requests the designated distributor for the delivery, and the designated distributor delivers the commodities. Even in this instance, similar effects to those described above can be anticipated.

While a preferred embodiment of the present invention has been described using specific terms, such description is for illustrative purposes only, and it is to be understood that changes and variations may be made without departing from the spirit or scope of the following claims.

What is claimed is:

1. An auction system, comprising:
a plurality of user terminals; and
a server connected to said-user terminals through a network and having an auction site formed therein for receiving bids from said user terminals and determining a successful bidder for an auction commodity based on the received bids;
said server exhibiting, in said auction site thereof, a delivery charge bearing object commodity which is to be sold by a dealer and with which part or all of a delivery charge for the auction commodity for which a user is determined as a successful bidder is to be borne so that the delivery charge bearing object commodity may be sold in combination with the auction commodity in response to a request from one of said user terminals.

2. An auction system, comprising:
a plurality of personal seller terminals and a plurality of participant terminals; and
an auction server connected to said personal seller terminals and said participant terminals through a network;
said auction server having an auction information reception storage function for receiving and storing auction commodity information from said personal seller terminals, an auction information transmission function for transmitting the auction commodity information to any of said participant terminals in response to a request from the participant terminal, and an auction function for receiving bidding information from said participant terminals based on the auction commodity information and determining a successful bidder based on the bidding information;
said auction server further having a dealer information reception storage function for receiving, from a dealer terminal owned by a predetermined dealer and connected to said auction server through said network, and storing dealer provision information including dealer commodity information which is information regarding a commodity to be sold by said dealer and delivery charge information which is information regarding the charge for delivery to be borne by said dealer in place of the person who purchases the dealer commodity;
said auction information transmission function placing and transmitting the dealer provision information into and together with the information to be transmitted to the participant terminal;
said auction function receiving purchase desired commodity information corresponding to the dealer provision information transmitted from said participant terminals together with the bidding information.

3. An auction system as claimed in claim 2, wherein said auction server further has an information classification function for classifying the auction commodity information from said personal seller terminals based on the auction commodity information and classifying the dealer provision information including the dealer commodity information from said dealer terminal based on the dealer commodity information, and a link registration function for linking the auction commodity information and the dealer provision information based on the classifications by said information classification function, and said auction information transmission function transmits the auction commodity information and the dealer provision information linked to each other by said link registration function to the participant terminal.

4. An auction system as claimed in claim 3, wherein the auction commodity information regarding each auction commodity includes information for specifying a classification of the auction commodity, and the dealer commodity information regarding the dealer commodity included in the dealer provision information includes information for specifying a classification of the dealer commodity.

5. An auction system as claimed in claim-3, wherein said auction server further has a delivery information reception storage function for receiving and storing distribution information of a plurality of predetermined distributors from distributor terminals owned by said distributors and connected to said auction server through said network, and said auction information reception storage function transmits, when auction commodity information is received from any of said personal seller terminals, the delivery information to the personal seller terminal and receives first distributor designation information which designates one of said distributors which is entrusted with delivery of the auction commodity by the personal seller while said dealer information reception storage function transmits, when auction commodity information is received from said dealer terminal, the delivery information to the personal seller terminal and receives second distributor designation information which designates one of said distributors which is entrusted with delivery of the dealer commodity by the dealer, said information classification function classifying the auction commodity information and the dealer provision information based on the first distributor designation information and the second distributor designation information.

6. An auction system as claimed in claim 2, wherein said auction server further has a delivery information reception storage function for receiving and storing distribution information of a predetermined distributor from a distributor terminal owned by said distributor and connected to said auction server through said network, and said auction information transmission function places and transmits the delivery information into and together with the information to be transmitted to the participant terminal while said auction function receives distributor designation information based on the delivery information from the participant terminal.

7. An auction system, comprising:
a plurality of personal seller terminals and a plurality of participant terminals; and
an auction server connected to said personal seller terminals and said participant terminals through a network;
said auction server having an auction information reception storage function for receiving and storing auction commodity information from said personal seller terminals, an auction information transmission function for transmitting the auction commodity information to any of said participant terminals in response to a request from the participant terminal, and an auction function for receiving bidding information from said participant terminals based on the auction commodity information and determining a successful bidder based on the bidding information;
said auction server further having a dealer information reception storage function for receiving, from a dealer terminal owned by a predetermined dealer and connected to said auction server through said network, and storing dealer provision information including dealer commodity information which is information regarding a commodity to be sold by said dealer and delivery charge information which is information regarding the charge for delivery to be borne by said dealer in place of the person who purchases the dealer commodity;
said auction information reception storage function transmitting, when auction commodity information is received from any of said personal seller terminals, the dealer provision information to the personal seller terminal, whereafter said auction information reception storage function issues a request to select one of commodities in the dealer commodity information included in the dealer provision information and desired to be sold together with the auction commodity by the personal dealer and then receives commodity selection information from the personal seller terminal transmitted thereto in response to the request;
said auction information transmission function placing the commodity selection information into the information to be transmitted to the participant terminal;
said auction function receiving purchase desired commodity information corresponding to the commodity selection information transmitted from said participant terminals together with the bidding information.

8. An auction system as claimed in claim 7, wherein the commodity selection information is information for selection of one commodity.

9. An auction system as claimed in claim 7, wherein said auction server further has a delivery information reception storage function for receiving and storing distribution information of a predetermined distributor from a distributor terminal owned by said distributor and connected to said auction server through said network, and said auction information transmission function places and transmits the delivery information into and together with the information to be transmitted to the participant terminal while said auction function receives distributor designation information based on the delivery information from the participant terminal.

10. An auction system, comprising:
a plurality of personal seller terminals and a plurality of participant terminals; and
an auction server connected to said personal seller terminals and said participant terminals through a network;
said auction server having an auction information reception storage function for receiving and storing auction commodity information from said personal seller terminals, an auction information transmission function for transmitting the auction commodity information to any of said participant terminals in response to a request from the participant terminal, and an auction function for receiving bidding information from said participant terminals based on the auction commodity information and determining a successful bidder based on the bidding information;
said auction server further having a dealer information reception storage function for transmitting the auction commodity information to a dealer terminal owned by a predetermined dealer and connected to said auction server through said network and receiving from said dealer terminal and storing dealer provision information including dealer commodity information which is information regarding a commodity to be sold by said dealer, auction commodity designation information which designates one of the auction commodities which said dealer hopes to be purchased together with the dealer commodity and delivery charge information which is information regarding the charge for delivery to be borne by said dealer in place of the person who purchases the dealer commodity;
said auction information, transmission function placing and transmitting the dealer provision information into and together with the information to be transmitted to the participant terminal.

11. An auction system as claimed in claim 10, wherein the auction commodity designation information is information which designates one of the auction commodities.

12. An auction system as claimed in claim 10, wherein said auction server further has a delivery information reception storage function for receiving and storing distribution information of a predetermined distributor from a distributor terminal owned by said distributor and connected to said auction server through said network, and said auction information transmission function places and transmits the delivery information into and together with the information to be transmitted to the participant terminal while said auction function receives distributor designation information based on the delivery information from the participant terminal.

13. An auction system, comprising:
a plurality of personal seller terminals and a plurality of participant terminals;
an auction server connected to said personal seller terminals and said participant terminals through a network; and
said auction server having an auction information reception storage function for receiving and storing auction commodity information from said personal seller terminals, an auction information transmission function for transmitting the auction commodity information to any of said participant terminals in response to a request from the participant terminal, and an auction function for receiving bidding information from said participant terminals based on the auction commodity information and determining a successful bidder based on the bidding information;
a dealer terminal owned by a predetermined dealer and connected to said auction server through said network, said dealer terminal having a dealer information transmission function for transmitting dealer provision information including dealer commodity information which is information regarding a commodity to be sold by said dealer and delivery charge information which is information regarding the charge for delivery to be borne by said dealer in place of the person who purchases the dealer commodity to said auction server;
said auction server further having a dealer information reception storage function for receiving and storing the dealer provision information;
said auction information transmission function of said auction server placing and transmitting the dealer provision information into and together with the information to be transmitted to the participant terminal;
each of said participant terminals having a bidding function for transmitting purchase desired commodity information corresponding to the dealer provision information to said auction server together with the bidding information;
said auction function of said auction server receiving the purchase desired commodity information corresponding to the dealer provision information transmitted from the participant terminal together with the bidding information.

14. An auction system as claimed in claim 13, further comprising a distributor terminal owned by a predetermined distributor and connected to said auction server through said network, and wherein said distributor terminal has a delivery information transmission function for transmitting delivery information of said distributor to said auction server and said auction server has a delivery information reception storage function for receiving and storing the delivery information from said distributor terminal, said auction information transmission function of said auction server placing and transmitting the delivery information into and together with the information to be transmitted to the participant terminal, said bidding function of the participant terminal transmitting distributor designation information based on the delivery information to said auction server together with the bidding information and the purchase desired commodity information, said auction function of said auction server receiving the distributor designation information from the participant terminal.

15. An auction program for causing an auction server connected to a plurality of personal seller terminals, a plurality of participant terminals and a dealer terminal owned by a predetermined dealer through a network to execute:
an auction information reception storage process for receiving and storing auction commodity information from said personal seller terminals;
a dealer information reception storage process for receiving from said dealer terminal and storing dealer provision information including dealer commodity information which is information regarding a commodity to be sold by said dealer and delivery charge information which is information regarding the charge for delivery to be borne by said dealer in place of the person who purchases the dealer commodity;
an auction information transmission process for transmitting the auction commodity information and the dealer provision information to any of said participant terminals in response to a request from the participant terminal; and
an auction process for receiving bidding information from said participant terminals based on the auction commodity information and purchase desired commodity information corresponding to the dealer provision information and determining a successful bidder based on the bidding information.

16. A recording medium on which an auction program is stored, the auction program causing an auction server connected to a plurality of personal seller terminals, a plurality of participant terminals and a dealer terminal owned by a predetermined dealer through a network to execute;
an auction information reception storage process for receiving and storing auction commodity information from said personal seller terminals;
a dealer information reception storage process for receiving from said dealer terminal and storing dealer provision information including dealer commodity information which is information regarding a commodity to be sold by said dealer and delivery charge information which is information regarding the charge for delivery to be borne by said dealer in place of the person who purchases the dealer commodity;
an auction information transmission process for transmitting the auction commodity information and the dealer provision information to any of said participant terminals in response to a request from the participant terminal; and
an auction process for receiving bidding information from said participant terminals based on the auction commodity information and purchase desired commodity information corresponding to the dealer provision information and determining a successful bidder based on the bidding information.
